(19) United States
(12) Patent Application Publication
(10) Pub. No.: US 2011/0310505 A1
(43) Pub. Date: Dec. 22, 2011

(54) MAGNETIC STORAGE DEVICE CAPABLE OF RECORDING DROP HEIGHT AND ELECTRONIC DEVICE USING THE SAME

(75) Inventor: Chia-Chang Chiu, Taipei County (TW)

(73) Assignee: GETAC TECHNOLOGY CORPORATION, HSINCHU (TW)

(21) Appl. No.: 12/818,963

(22) Filed: Jun. 18, 2010

(51) Int. Cl. G11B 21/02

(52) U.S. Cl. 360/75; G9B/21.003

(57) ABSTRACT

A magnetic storage device capable of recording a drop height and an electronic device using the same are presented. The magnetic storage device includes: a G-sensor, installed in the magnetic storage device, for outputting a first trigger signal when the magnetic storage device starts to drop and outputting a second trigger signal when the magnetic storage device stops dropping; a timer, for calculating a duration between the first trigger signal and the second trigger signal, and recording the duration as a drop time; a logic operation processor, having a built-in height calculation formula, for calculating a drop height according to the drop time; and a memory unit, for storing the drop time and the drop height. An electronic device using the magnetic storage device is also presented, which is capable of record the actual drop height when a drop event occurs on the electronic device.

### BACKGROUND OF THE INVENTION

1. Field of Invention

The present invention relates to a magnetic storage device and an electronic device using the same, and more particularly to a magnetic storage device capable of detecting and recording a drop height when a drop event occurs and an electronic device using the same.

2. Related Art

Hard disk drive is a widely used magnetic storage device. In order to prevent the hard disk drive from being damaged by an impact of an external force or drop, many protection methods have been proposed, for example, a G-sensor is installed in the hard disk drive, such that when the G-sensor detects the impact of an external force or drop, a protection mechanism is activated to achieve the efficacy of protecting the hard disk drive.

According to existing technologies, for example as the Taiwan Patent No. 1256053 entitled Magnetic Storage Device Capable of Preventing Drop Damage and Electronic Product Using the Same, an acceleration detector senses the drop of a disk body and outputs an acceleration detection signal, so as to cut off the power supply loop to prevent the damage to the disk body caused by dropping down from a high position. Furthermore, in Taiwan Patent No. 491940 entitled Fall Sensor, a method of protecting a hard disk drive is provided, which is substantially to install a fall sensor in the hard disk drive, such that when the fall sensor detects that a fall event occurs on the hard disk drive, a read write head of the hard disk drive is moved to a safe position out of the magnetic disk, so as to prevent collision between the read write head and a surface of the magnetic disk. In the patent technology of Taiwan Patent Publication No. 200725592 entitled Electronic Device Having Hard Disk with Electronic Shock Protection, a magnetic sensor is used to detect an action of the electronic device, and control the hard disk to activate a protection mechanism when the electronic device has severe spatial displacement.

Although electronic device manufacturers have set forth the above protection methods, the electronic storage device cannot be completely protected from being damaged by an external force or drop, so the manufacturers generally provide appropriate product warranty service. As long as the damage is generated under normal using condition, the damage is still covered by the product warranty, for example, if an electronic storage device drops down from a height in a height range ensured to be safe and is damaged, the manufacturers will provide maintenance or renewal service; otherwise, the damage caused by improper use is not covered by the product warranty for normal use. However, whether the electronic storage device is damaged in normal use cannot be determined easily, and the maintenance personnel can merely know the causes of damage from the description of the user, and cannot verify the damage reason with other objective and scientific methods. Therefore, if the user and the manufacturer have different opinions, consumer disputes are likely to arise.

### SUMMARY OF THE INVENTION

Accordingly, the present invention is a magnetic storage device capable of recording a drop height, which is applicable in detecting and recording the drop height when a drop event occurs on the magnetic storage device such as a hard disk drive.

In order to achieve the above objective, a preferred implementation of a drop recorder comprises: a G-sensor for driving a timer when a drops starts and stops to record a duration of the drop of a magnetic storage device, and an operation processor having a built-in height calculation formula for calculating a drop height of the magnetic storage device according to the duration of the drop, and storing the drop height in a memory unit.

The present invention is an electronic device capable of recording a drop height, which is capable of providing reference information to a product manufacturer when the product manufacturer fulfills maintenance guarantee for a user after a drop event occurs on the electronic product.

In order to achieve the above objective, a preferred implementation of the present invention is to dispose a magnetic storage device capable of recording a drop height in an electronic product. The magnetic storage device comprises a drop recorder, and the drop recorder comprises a G-sensor for driving a timer when a drop starts and stops to record a duration of the drop of the electronic product, and an operation processor having a built-in height calculation formula for calculating a drop height of the electronic product according to the duration of the drop, and storing the drop height in a memory unit.

Therefore, the efficacy achieved through the present invention is that when a drop event occurs on the electronic product, the device manufacturer can acquire the information about the actual drop height, so as to provide reference information when fulfilling maintenance guarantee for the user.

### BRIEF DESCRIPTION OF THE DRAWINGS

The present invention will become more fully understood from the detailed description given herein below for illustration only, and thus are not limitative of the present invention, and wherein:

FIG. 1 shows a preferred embodiment of a magnetic storage device capable of recording a drop height;

FIG. 2 shows a preferred embodiment of an electronic device using a magnetic storage device capable of recording a drop height; and

FIG. 3 shows steps of a preferred embodiment of recording a drop height.

### DETAILED DESCRIPTION OF THE INVENTION

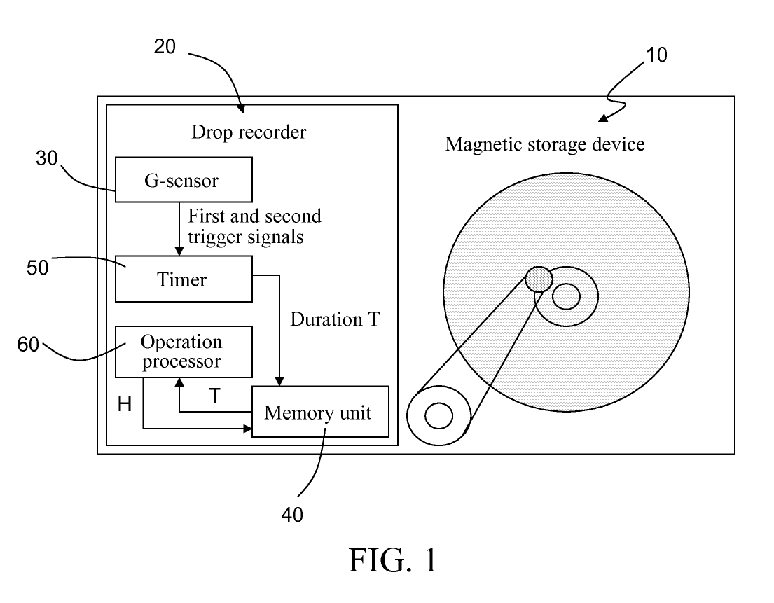

FIG. 1 shows a preferred embodiment of a magnetic storage device 10 capable of recording a drop height. Specifically, the magnetic storage device 10 may be a hard disk drive or the like, in which the hard disk drive has a drop recorder 20 installed therein, to detect and record a drop height when a drop event occurs on the magnetic storage device 10. A preferred embodiment of the drop recorder 20 comprises a G-sensor 30, a memory unit 40, a timer 50, and an operation processor 60.

The G-sensor 30, or so-called accelerometer, is installed in the magnetic storage device 10, and is capable of sending out a first trigger signal when the magnetic storage device 10 starts to drop and sending out a second trigger signal when the magnetic storage device 10 stops dropping.

The memory unit 40 stores data, and may be a non-volatile memory in a preferred embodiment, for example, an electrically-erasable programmable read-only memory (EEPROM) or a flash memory.

The timer 50 is triggered to start to time by the first trigger signal of the G-sensor 30, and is triggered to stop timing by the second trigger signal of the G-sensor 30, calculates a duration T between the first trigger signal and the second trigger signal, and stores the duration T in the memory unit 40 as a drop time.

The operation processor 60 has a built-in height calculation formula (see Formula 1 as an example follows), calculates a drop height H of the magnetic storage device 10 according to the duration T of the drop, and stores the drop height H in the memory unit 40, so as to provide reference information for a product manufacturer when the product manufacturer fulfills the maintenance guarantee of the product.

H=(G*T̂2)/2 Formula 1

Therefore, the magnetic storage device 10 equipped with the drop recorder 20 can record the duration T of the drop of the magnetic storage device 10 with the timer 50 when the drop starts and stops, calculate the drop height H of the magnetic storage device 10 according to the duration T of the drop with the operation processor 60 having a built-in height calculation formula, and store the drop height H in the memory unit 40. Therefore, after the drop event occurs on the magnetic storage device 10, the device manufacturer can obtain actual information of the drop height H, so as to provide important reference information when fulfilling the maintenance guarantee for the user.

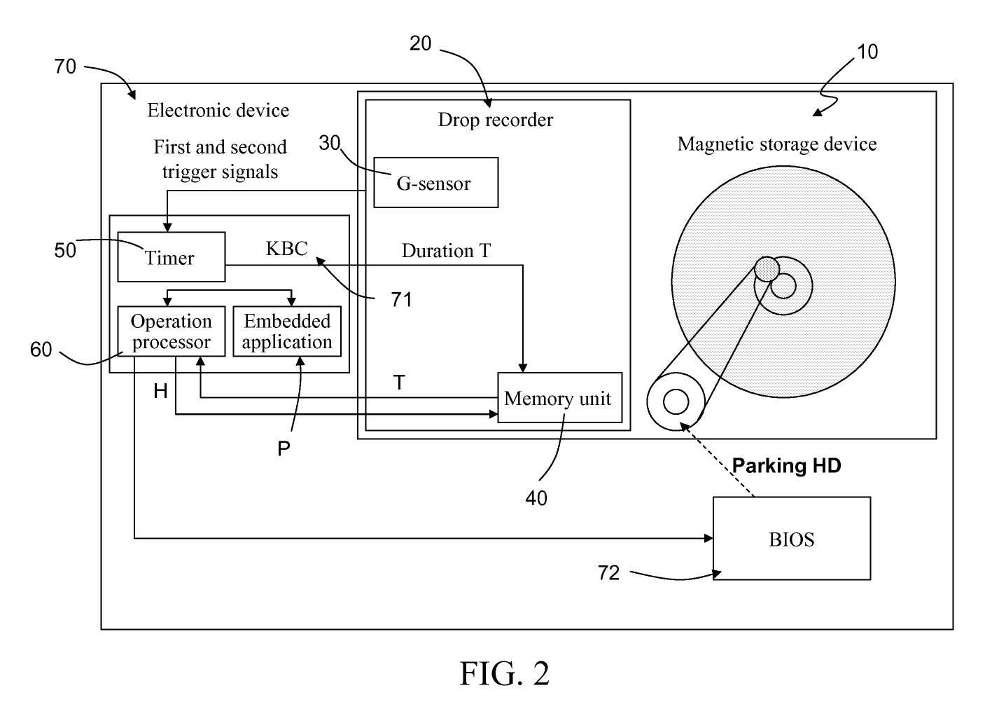

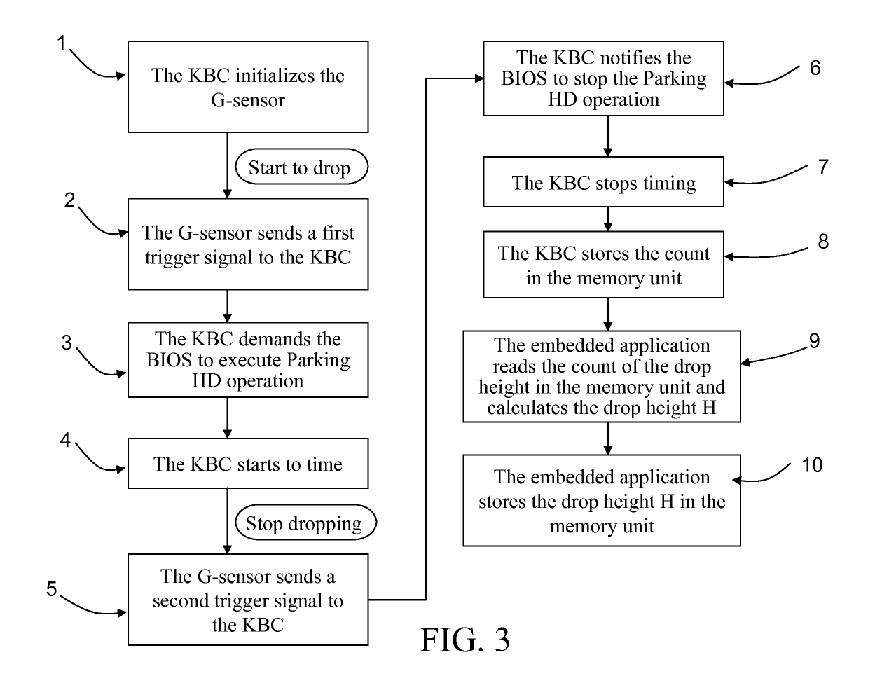

FIG. 2 shows a preferred embodiment of an electronic device 70 using a magnetic storage device 10 capable of recording a drop height. Referring to FIG. 2, the magnetic storage device 10 capable of recording the drop height is installed in a body of the electronic device 70. The electronic device 70 may be a note-book computer, a digital camera using a hard disk drive, or other handheld electronic devices 70 using a hard disk drive. Taking the note-book computer as an example, the preferred implementation of the timer 50 and the operation processor 60 may be directly using a keyboard controller (KBC) 71 of the note-book computer. By adding an embedded application P in the KBC 71, the drop height H can be calculated and the duration T of the drop can be recorded. The operation method and steps are as shown in FIG. 3.

1. When a system of the note-book computer is booted, the KBC 71 initializes the G-sensor 30.

2. When a drop event occurs, the G-sensor 30 sends a first trigger signal to the KBC 71, and the first trigger signal is considered by the embedded application P of the KBC 71 as an interrupt signal.

3. When receiving the first trigger signal, the KBC 71 demands a basic input/output system (BIOS) 72 of the note-book computer to execute a protection action (generally referred to as parking HD) of removing a read write head of the magnetic storage device 10 (hard disk drive) to a safe stop area.

4. The KBC starts to count the drop height with 5 micro seconds (ms) as a timing unit simultaneously.

5. When the drop stops, the G-sensor 30 sends a second trigger signal to the KBC 71, and the second trigger signal is also considered by the embedded application P of the KBC 71 as an interrupt signal.

6. The KBC 71 notifies the BIOS 72 to release the protection action (generally referred to as un-parking HD).

7. The KBC 71 receives the second trigger signal, and stops counting the drop height with 5 ms as the timing unit simultaneously.

8. The KBC 71 stores the count of the drop height in the memory unit 40.

9. The embedded application P reads the count of the drop height in the memory unit 40 (each count is equivalent to a time duration of 5 ms), and calculates the actual drop height H according to the height calculation formula (as Formula 1 for an example).

10. The embedded application P stores the drop height H in the memory unit 40.

Therefore, after a drop event occurs on the electronic device 70 using the magnetic storage device 10 capable of recording the drop height, the device manufacturer can acquire the information about the actual drop height H from the memory unit, so as to provide important reference information when fulfilling the maintenance guarantee for the user.

1. A storage device capable of recording a drop height, comprising:
a magnetic storage device;
a G-sensor, capable of sending out a first trigger signal when the magnetic storage device starts to drop and sending out a second trigger signal when the magnetic storage device stops dropping;
a memory unit, for storing data;
a timer, triggered by the first trigger signal to start to time, and triggered by the second trigger signal to stop timing, for calculating a duration T between the first trigger signal and the second trigger signal, and storing the duration T in the memory unit as a drop time; and
an operation processor, having a built-in height calculation formula, for calculating a drop height H of the magnetic storage device according to the duration T of the drop by means of the formula, and storing the drop height H in the memory unit.

2. The storage device capable of recording the drop height according to claim 1, wherein the formula is defined as H=(G*T̂2)/2.

3. The storage device capable of recording the drop height according to claim 1, wherein the magnetic storage device is a hard disk drive.

4. The storage device capable of recording the drop height according to claim 1, wherein the memory unit is one selected from a group consisting of an electrically-erasable programmable read-only memory (EEPROM) and a flash memory.

5. An electronic device, comprising:
a magnetic storage device, installed in the electronic device;
a G-sensor, capable of sending out a first trigger signal when the magnetic storage device starts to drop and sending out a second trigger signal when the magnetic storage device stops dropping;
a memory unit, for storing data;
a timer, triggered to start to time by the first trigger signal, and triggered to stop timing by the second trigger signal, for calculating a duration T between the first trigger signal and the second trigger signal, and storing the duration T in the memory unit as a drop time; and
an operation processor, having a built-in height calculation formula, for calculating a drop height H of the magnetic storage device according to the duration T of the drop by means of the formula, and storing the drop height H in the memory unit.

6. The electronic device according to claim 5, wherein the formula is defined as H=(G*T̂2)/2.

7. The electronic device according to claim 5, wherein the electronic device is a note-book computer.

8. The electronic product according to claim 7, wherein the note-book computer has a keyboard controller (KBC) and an embedded application, and executes functions of the timer and the operation processor by using the KBC and the embedded application, so as to calculate the drop height H.

9. The electronic device according to claim 5, wherein the electronic device is a digital camera using a hard disk drive.

10. The electronic deice according to claim 5, wherein the magnetic storage device is a hard disk drive.

11. The electronic device according to claim 5, wherein the memory unit is one selected from a group consisting of an electrically-erasable programmable read-only memory (EEPROM) and a flash memory.
